(19) United States
(12) Patent Application Publication
(10) Pub. No.: US 2005/0139811 A1
(43) Pub. Date: Jun. 30, 2005

(54) Surface preparation method for articles manufactured from conductive loaded resin-based materials

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/060,273

(22) Filed: Feb. 17, 2005

Related U.S. Application Data
(63) Continuation-in-part of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/553,313, filed on Mar. 15, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. H01C 1/00

(52) U.S. Cl. 252/512

(57) ABSTRACT

A molded conductive loaded resin-based product is processed to reduce surface resistivity. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, aluminum fiber, or the like.

This Patent Application claims priority to the U.S. Provisional Patent Application 60/553,313, filed on Mar. 15, 2004, which is herein incorporated by reference in its entirety.

This Patent application is a Continuation-in-Part of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to molded articles and, more particularly, to a surface preparation method for articles molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Resin-based polymer materials are used for the manufacture of a wide array of articles. These polymer materials combine many outstanding characteristics, such as excellent strength to weight ratio, corrosion resistance, electrical isolation, and the like, with an ease of manufacture using a variety of well-established molding processes. Many resin-based polymer materials have been introduced into the market to provide useful combinations of characteristics.

In a typical scenario, these resin-based polymer materials are manufactured in bulk quantities by a chemical manufacturer as a raw material. This raw material is then sold to a molding operation where it is molded into particular articles. This raw material form of the resin-based polymer material typically comprises a plurality of small pieces called pellets or granules. These pellets are typically of uniform size, shape, and chemical constituency. At the molding operation, the pellets are loaded into a molding apparatus, such as an injection molding machine or an extrusion machine. The pellets are typically processed through a heating and mixing process in the apparatus where the material is converted from the solid state into the molten state prior to molding.

Most resin-based polymer materials are poor conductors of thermal and electrical energy. These characteristics are advantageously used in many applications. For example, the handles of metal cooking pans are frequently covered by a molded polymer material to provide a cool handling point for the heated pan. Many electrical interfaces, such as light switches, use resin-based polymers to prevent electrical exposure to the operator. These characteristics can be disadvantageous, however, in extending the use of resin-based polymer materials to applications long dominated by metal materials. For example, it is desirable to reduce weight of electrical and electronic circuit components used in airplanes. These components frequently comprise electrically conductive materials, such as copper, that add substantial weight to an airplane. Replacement of copper with a resin-based material would reduce the weight of the component and, by extension, the entire airplane. Unfortunately, most resin-based materials are not electrically conductive enough to be used as conductors.

Attempts have been made in the art to create intrinsically and non-intrinsically conductive resin-based materials. Intrinsically conductive resin-based materials incorporate molecular structures into the polymer to increase the conductivity of the material. Unfortunately, intrinsically conductive resin-based materials are expensive and provide only limited increases in conductivity. Non-intrinsically conductive resin-based materials are formed by incorporating conductive fillers into the base resin material to impute an increased conductivity to the composite material. Metallic and non-metallic fillers have been demonstrated in the art to provide substantially increased conductivity in the composite material.

In the present invention, a particular conductive loaded resin-based material is described that exhibits excellent bulk conductivity. However, it is found molded articles may exhibit localized areas of reduced exposure of the conductive lattice network at the surface due to random phenomenon and due to surface skinning effects. The contact resistance at these areas of reduced exposure is found to be substantially higher than that of the molded bulk material. A primary purpose of the present invention is to improve surface conductivity of the molded conductive loaded resin-based material via a surface treatment.

Several prior art inventions relate to plastic etching. U.S. Pat. No. 5,332,465 to Kuzmik et al describes a method to etch a plastic surface prior to a metal plating step. The etch roughens the plastic surface to improve metal coverage and adhesion. Wet chemical etch solutions, such as alkali metal hydroxides, sulfuric acid, chromic acid, and permanganate solutions are disclosed. U.S. Pat. No. 4,851,081 to Forschirm teaches a method to form conductive plastic articles where metal is plated onto the plastic. Prior to metal plating, the plastic is etched to improve adhesion. Several wet etching solutions, including organic and inorganic acids, are disclosed. U.S. Pat. No. 5,296,091 to Bartha et al teaches a method to etch a low thermal conductivity plastic substrate using a vacuum reactor (plasma or reactive ion etch). U.S. Pat. No. 5,683,540 to Lukins et al teaches a method and an apparatus to prepare/clean/remove a surface layer from a material by dry etching. The material may include a non-metallic material. U.S. Pat. No. 4,643,798 to Takada et al teaches a composite circuit board that is subject to electroless plating.

### SUMMARY OF THE INVENTION

A principal object of the present invention is to provide an effective method of surface preparation of an article molded of conductive loaded resin-based material.

A further object of the present invention is to provide a method that improves the surface conductivity of the conductive loaded resin-based material.

A further object of the present invention is to provide a method that is applicable using a variety of processing equipment.

In accordance with the objects of this invention, a method to form a conductive loaded resin-based article is achieved. The method comprises molding a conductive loaded resin-based material into an article. The conductive loaded resin-based material comprises conductive materials in a base resin host. A surface of the article is processed to remove a portion of the base resin host and to expose the conductive material.

Also in accordance with the objects of this invention, a method to form a conductive loaded resin-based article is achieved. The method comprises molding a conductive loaded resin-based material into an article. The conductive loaded resin-based material comprises conductive materials in a base resin host. The percent by weight of the conductive materials is between 20% and 40% of the total weight of the conductive loaded resin-based material. A surface of the article is processed with a solvent to remove a portion of the base resin host and to expose the conductive material.

Also in accordance with the objects of this invention, a method to form a conductive loaded resin-based article is achieved. The method comprises molding a conductive loaded resin-based material into an article. The conductive loaded resin-based material comprises micron conductive fiber in a base resin host. A surface of the article is processed with a high pressure jet to remove a portion of the base resin host and to expose the micron conductive fiber.

Also in accordance with the objects of this invention, a device is achieved. The device comprises conductive loaded, resin-based material comprising conductive materials in a base resin host. The conductive loaded, resin-based material is molded to form surfaces of the device. At least one molded surface is processed, after molding, to remove a portion of the base resin host and to expose the conductive material.

Also in accordance with the objects of this invention, a device is achieved. The device comprises conductive loaded, resin-based material comprising conductive materials in a base resin host. The conductive loaded, resin-based material is molded to form surfaces of the device. Between 20% and 40% by weight of the conductive loaded, resin-based material is the conductive material. At least one molded surface is processed with a solvent, after molding, to remove a portion of the base resin host and to expose the conductive material.

Also in accordance with the objects of this invention, a device is achieved. The device comprises conductive loaded, resin-based material comprising micron conductive fiber in a base resin host. The conductive loaded, resin-based material is molded to form surfaces of the device. At least one molded surface is processed with a high pressure jet, after molding, to remove a portion of the base resin host and to expose the micron conductive fiber.

### BRIEF DESCRIPTION OF THE DRAWINGS

In the accompanying drawings forming a material part of this description, there is shown:

FIGS. 1a and 1b illustrate a first preferred embodiment of the present invention showing an article molded of conductive loaded resin-based material before and after the surface of the article has been processed using the method of the present invention.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold an article of a conductive loaded resin-based material.

FIG. 7 illustrates a second preferred embodiment of the present invention showing a dip and rinse process for etching the surface polymer of the conductive loaded resin-based material.

FIG. 8 illustrates a third preferred embodiment of the present invention showing a spray and wipe process for etching the surface polymer of the conductive loaded resin-based material.

FIG. 9 illustrates a fourth preferred embodiment of the present invention showing a high pressure jet process for removing the surface polymer of the conductive loaded resin-based material.

FIG. 10 illustrates a fifth preferred embodiment of the present invention showing a laser etching process to remove the surface polymer of the conductive loaded resin-based material.

FIG. 11 illustrates a sixth preferred embodiment of the present invention showing an abrasive media blasting process to remove the surface polymer of the conductive loaded resin-based material.

FIG. 12 illustrates a seventh preferred embodiment of the present invention showing a planing process to remove the surface polymer of the conductive loaded resin-based material.

FIG. 13 illustrates an eighth preferred embodiment of the present invention showing a reactive plasma etching process to etch the surface polymer of the conductive loaded resin-based material.

FIG. 14 illustrates a ninth preferred embodiment of the present invention showing an abrasive buffing process to remove the surface polymer of the conductive loaded resin-based material.

### DESCRIPTION OF THE PREFERRED EMBODIMENTS

This invention relates to articles molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of articles fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the articles are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

The use of conductive loaded resin-based materials in the fabrication of articles significantly lowers the cost of materials and the design and manufacturing processes used to hold ease of close tolerances, by forming these materials into desired shapes and sizes. The articles can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, aluminum fiber, or the like, or combinations thereof. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the article. The doping composition and directionality associated with the micron conductors within the loaded base resins can affect the electrical and structural characteristics of the article and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, articles manufactured from the molded conductor loaded resin-based material can provide added thermal dissipation capabilities to the application. For example, heat can be dissipated from electrical devices physically and/or electrically connected to a molded article of the present invention.

As a significant advantage of the present invention, molded articles constructed of the conductive loaded resin-based material can be easily interfaced to an electrical circuit or grounded. In one embodiment, a wire can be attached to a conductive loaded resin-based article via a screw that is fastened to the article. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

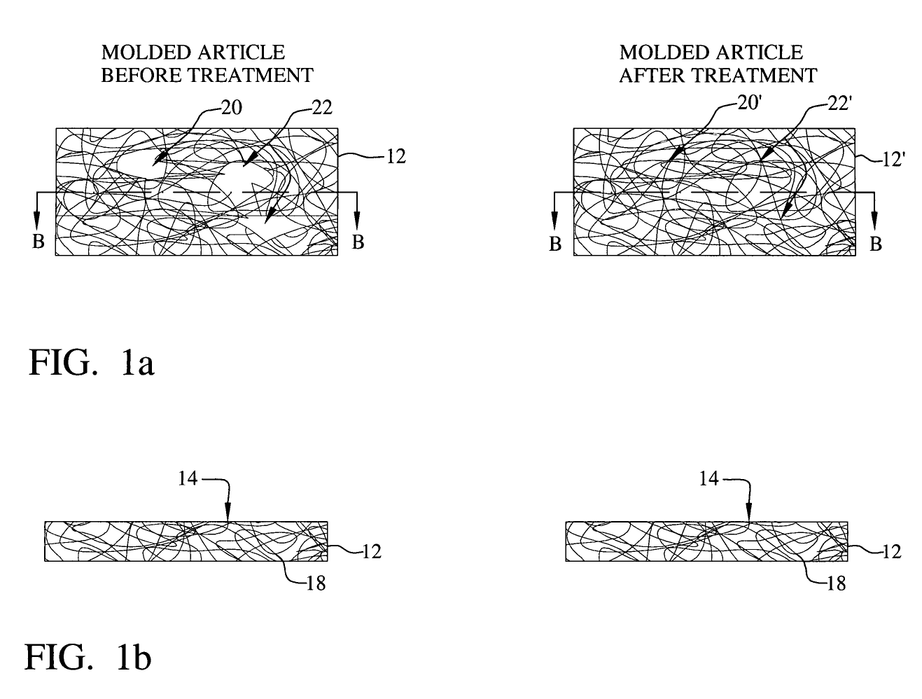

Referring now to FIGS. 1a and 1b, a first preferred embodiment of the present invention is illustrated. Several important features of the present invention are shown and discussed below. More particularly, FIG. 1a illustrates a top view of an article 12 molded from a conductive loaded resin-based material and the same article 12′ after it has been further processed using the surface preparation method of the present invention. FIG. 1b illustrates a cross sectional view of the article before and after the surface preparation method.

When the conductive loaded resin-based material molded article 12 is removed from the molding process, the article 12 exhibits the desired shape as controlled by the mold surfaces. Due to the substantial homogenization of conductive loaded materials into the resin base during the molding process, the lattice structure of the conductive network 18 is found to extend throughout the molded part 12 as shown by the cross section. However, it is additionally found that, the external surfaces, such as the top 14, of the molded part may display two phenomenon that may increase the surface resistivity. First, the homogenization process of the molding machine causes the conductive micron fibers, powders, and or combination of fibers and powders to be omni-directionally oriented. However, the lattice structure of the conductive network 18 may not be protruding at all areas of the surface 14 equally due to local fiber orientations. More particularly, in certain locations 22, the lattice structure of the conductive network will protrude less densely than in other locations 20. As a result, the surface resistivity will be greater than expected in these local areas 22.

A second phenomenon that creates locations 22 of increased surface resistivity is skinning. Skinning is caused by differences in temperature between the mold and the molten base resin material. Skinning also results in less of the lattice structure of the conductive network 18 protruding at certain areas 22 of the surface 14. As a result, the surface resistivity will be greater than expected in these local areas 22.

As important feature of the present invention, a surface preparation process is performed to reduce the surface resistivity of the molded part 12′ in the regions 22′ affected by either of the above-described phenomena. The surface process, in its most generic sense, entails the removal of a portion of the base resin material at the surface of the molded part 12′ to thereby expose more of the inner matrix 18′. As a result, the conductive network is equally exposed in both regions 20′ and 22′. The surface resistivity is reduced at locations 22′ that had formerly exhibited high resistivity.

Particular surface processes useful for reducing surface resistivity according to the present invention include applying a solvent capable of dissolving the base resin, dry reactive, or plasma, etching, sand-blasting and/or other abrasive-solution mechanical removal, laser etching, pressurized water jetting, high pressure air jetting, plastic planarization, or abrasive polishing.

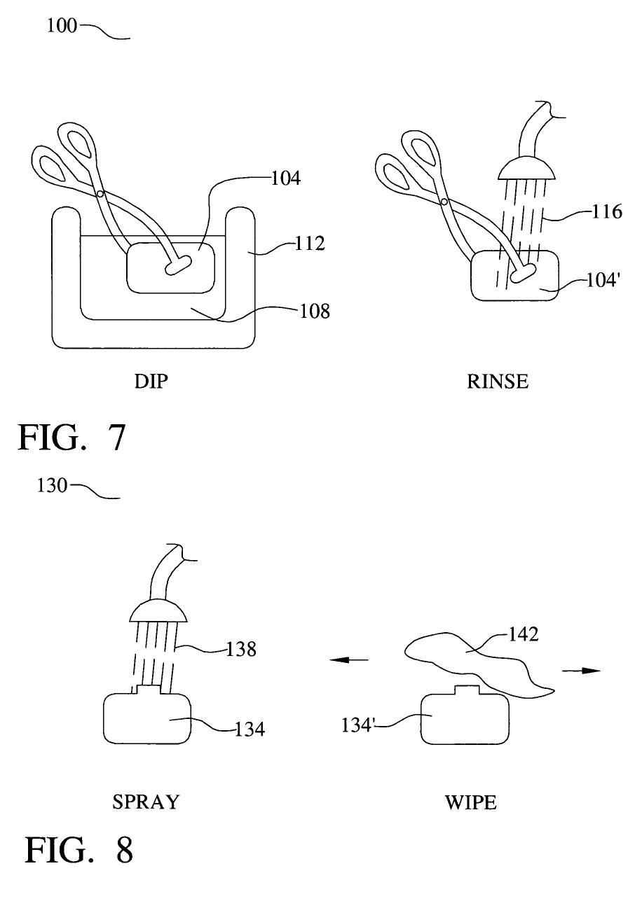

Referring now to FIG. 7, a second preferred embodiment of the present invention is illustrated. In this embodiment, the surface of the article 104 is processed using a dip and rinse method 100. The molded conductive loaded resin-based material article 104 is first dipped into a tank 112 containing a solution 108 capable of dissolving or of etching the base resin material. The particular type of solution 108 depends on the type of base resin used in the molded article 104. For example, inorganic acid species, such as hydrochloric acid, sulfuric acid, chromic acid, permanganate solution, and alkali metal hydroxides, and organic solvents, such as tetrahydrofuran, dimethylsulfoxide, dimethylformamide, and acetone, are useful for dissolving or etching resin-based materials. More preferably, the solution comprises a species that selectively dissolves or etches the base resin while not chemically attacking the conductive loading. The molded article 104 is dipped into the solution 108 for a specified time period. After removal from the dipping tank 112, the molded article 104 may then be subjected to an additional time of exposure to the solution through additional dipping or through a wait time. During this process, the solution chemically dissolves or etches the base resin from the outer surface to reveal more of the inner lattice of conductive loading. Finally, a rinsing process is used to flush away the solvent solution 108 from the etched article 104′. Many flushing solutions 116, such as water, are known in the art. By carefully controlling the dipping and waiting times, the depth of resin-based material removed during the process can be controlled.

Referring now to FIG. 8, a third preferred embodiment of the present invention is illustrated. In this embodiment, the surface of the article 134 is processed using a spray and wipe method 130. The molded conductive loaded resin-based material article 134 is first sprayed with a solution 138 capable of dissolving or of etching the base resin material. Again, the particular type of solution 138 depends on the type of base resin used in the molded article 134. For example, inorganic species, such as hydrochloric acid, sulfuric acid, chromic acid, permanganate solution, and alkali metal hydroxides, and organic solvents, such as tetrahydrofuran, dimethylsulfoxide, dimethylformamide, and acetone, are useful for dissolving or etching resin-based materials. More preferably, the solution comprises a species that selectively dissolves or etches the base resin while not chemically attacking the conductive loading. The molded article 134 is sprayed with the solution 138 for a specified time period. Next, the molded article 134 may then be subjected to an additional time of exposure to the solution through additional spraying or through a wait time. During this process, the solution chemically dissolves or etches the base resin from the outer surface to reveal more of the inner lattice of conductive loading. Finally, a wiping process is used to remove the solvent solution 138 from the etched article 134′. In one embodiment, a cloth 142 is used to remove the remaining solution from the etched article 134′. By carefully controlling the spraying and waiting times, the depth of resin-based material removed during the process can be controlled.

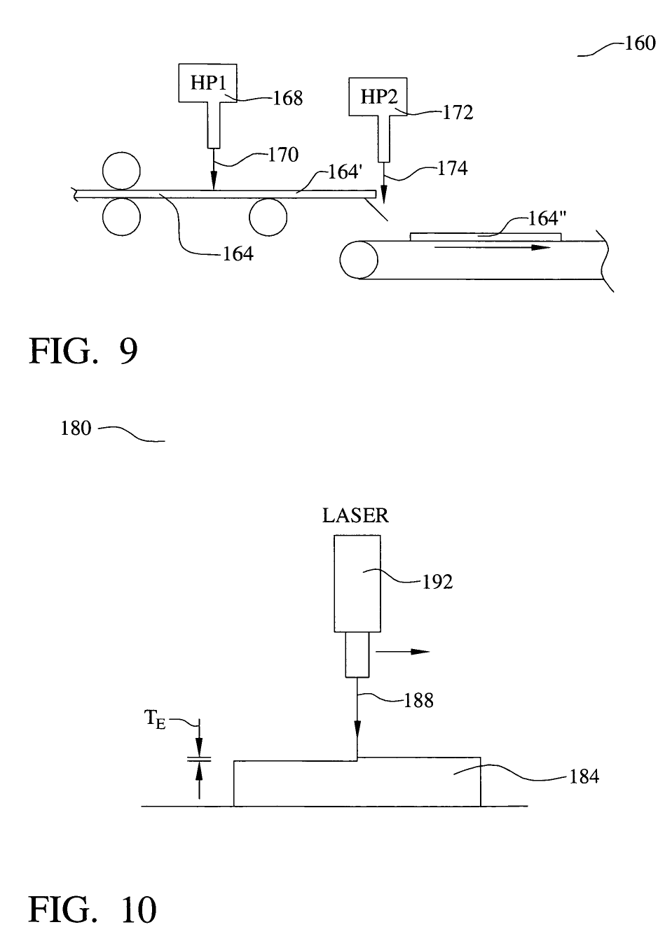

Referring now to FIG. 9, a fourth preferred embodiment of the present invention is illustrated. In this embodiment, the surface of the article 164 is processed using a high pressure jet method 160. The molded conductive loaded resin-based material article 164 is sprayed with a high pressure jet 170 and 174 capable of etching the base resin material. In this embodiment, the high pressure jet 170 and 174 cuts the material by impact force. Preferably, the high pressure jet 170 and 174 is water, or air, that is pressurized via compression mechanisms HP1 168 and HP2 172 such that, when released, this water, or air, forms a pressurized cutting jet capable of mechanically etching the base resin. More preferably, the high pressure jet 170 and 174 etches the base resin while not mechanically attacking the conductive loading.

In the illustrated embodiment, the surface of the molded article 164 is subjected to the first high pressure jet 170 to remove a surface layer of the base resin while revealing more of the inner lattice of conductive loading in the treated article 164′. By carefully controlling the jet energy, dispersal, and exposure time, the depth of resin-based material removed during the process can be controlled. Next, the treated article 164′ is subjected to a second high pressure jet 174. In this embodiment, the second jet 174 is used to cutoff the treated article 164′ into sections 164″.

Referring now to FIG. 10, a fifth preferred embodiment of the present invention is illustrated. In this embodiment, the surface of the article 184 is processed using a laser cutting method 180. The molded conductive loaded resin-based material article 184 is exposed to laser light 188 capable of etching the base resin material. In this embodiment, the laser light 188 cuts the material by heating and/or vaporization. A laser 192 is used to generate, focus, and control the laser light 188. Preferably, the laser light 188 etches the base resin while not mechanically attacking the conductive loading. In the illustrated embodiment, the surface of the molded article 184 is subjected to the laser light 188 to remove a specified thickness TE of the surface layer of the base resin while revealing more of the inner lattice of conductive loading in the treated article 184. By carefully controlling the wavelength, intensity, depth of focus, and exposure time, the depth TE of resin-based material removed during the process can be controlled.

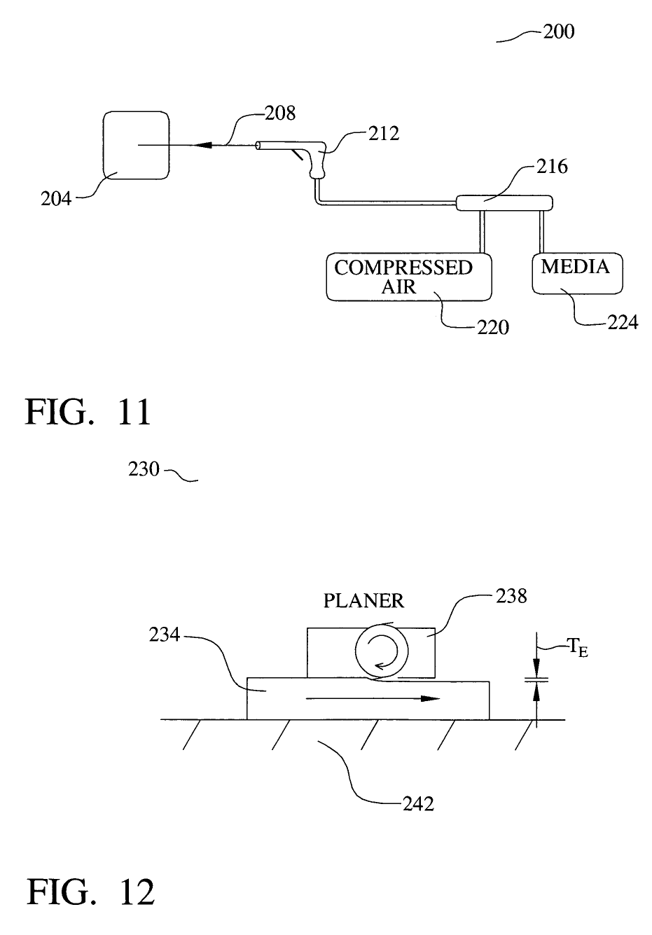

Referring now to FIG. 11, a sixth preferred embodiment of the present invention is illustrated. In this embodiment, the surface of the article 204 is processed using a high pressure media method 200. The molded conductive loaded resin-based material article 204 is sprayed with a high pressure abrasive media 208 capable of etching the base resin material. In this embodiment, the high pressure media 208 cuts the material by impact force. Preferably, the high pressure abrasive media 208 is an abrasive particulate material, such as silica oxide, or sand, that is pressurized. In the illustrative embodiment, compressed air 220 is mixed with the abrasive media 224 in a mixing chamber 216. A control nozzle 212 is used to direct the pressurized media to mechanically etch the base resin of the molded article 204. More preferably, the high pressure media 208 etches the base resin while not mechanically damaging the conductive loading. In the illustrated embodiment, the surface of the molded article 204 is subjected to the high pressure media to remove a surface layer of the base resin while revealing more of the inner lattice of conductive loading in the treated article 204. By carefully controlling the pressure, dispersal, and exposure time, the depth of resin-based material removed during the process can be controlled.

Referring now to FIG. 12, a seventh preferred embodiment of the present invention is illustrated. In this embodiment, the surface of the article 234 is processed using a cutting plane method 230. The molded conductive loaded resin-based material article 234 is processed through a mechanical cutting plane 238 capable of mechanically removing a layer of the conductive loaded resin-based material. In this embodiment, the planer 238 cuts the material by slicing force. Preferably, a motor-driven planar 238 is used. Alternatively, a hand-driven planar may be used. The surface of the molded article 234 is cut to remove a layer of the conductive loaded resin-based material. The layer removed has a thickness TE based on the set up of the cutting blade with respect to the planer support surface 242. The removal of a surface layer of the base resin reveals more of the inner lattice of conductive loading in the molded article 234.

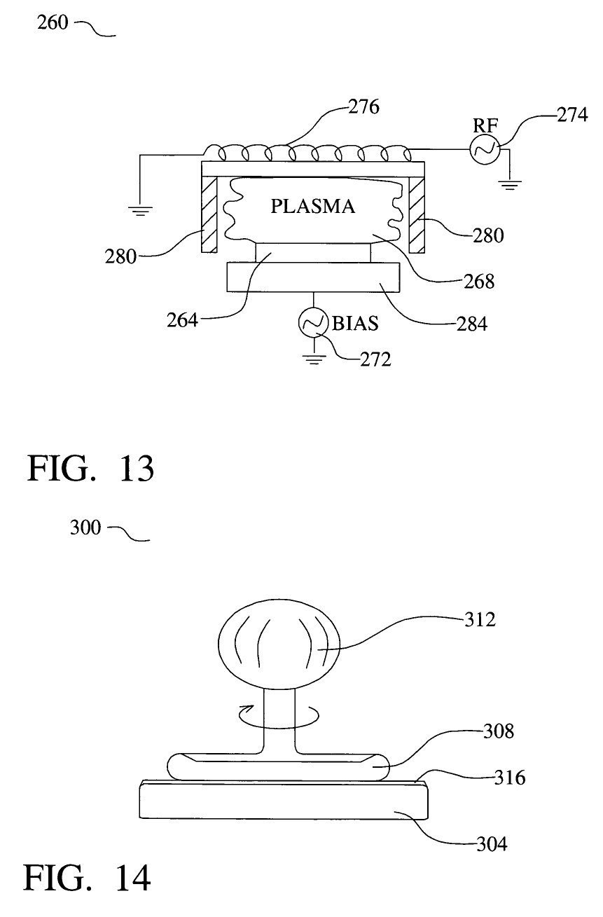

Referring now to FIG. 13, an eighth preferred embodiment of the present invention is illustrated. In this embodiment, the surface of a molded article 264 is processed using a dry reactive plasma method 260. The molded conductive loaded resin-based material article 264 is subjected to a reactive plasma 268. The reactive plasma 268 is formed by the reaction of a gas, typically at sub-atmospheric pressure, with a high energy radio frequency field. The RF energy ionizes the gas molecules to form a high energy plasma 268. Depending on the gas species, the plasma 268 is capable of etching a material with a high degree of directionality and/or selectivity. The plasma may be manipulated and directed using magnetic and/or electric fields. In the illustrative embodiment, a coil 276 is used to transmit a high energy RF signal 274 into the plasma gas 268. Magnets 280 are used to manipulate the plasma via magnetic fields. A voltage bias 272 is placed onto the molded article 264 via a conductive stage 284.

In the preferred embodiment, the molded article 264 is placed in a reacting chamber, and the chamber is evacuated to a very low pressure (vacuum). A reacting gas and, optionally, a cooling gas are then flowed into the chamber. In one embodiment, oxygen is used as the reacting gas, while argon is used as the cooling gas. Under plasma conditions, oxygen has excellent properties for etching organic compounds such as the base resin while not disturbing the metallic conductive loading. However, since the glass transition temperature of many base resins is not very high, the argon cooling gas may be needed to remove heat from the article 264. The oxygen gas is ionized into plasma 268 by the high energy RF signal 274 coupled into the reactor by the RF coil 276. This plasma 268 is directed to the molded article 264 by the magnetic and electric fields generated by the magnets 280 and the voltage bias 272. The plasma 268 impacts the surface of the molded article 264 and reacts with the base resin to effectively etch away the base resin at a predictable rate. The removal of a surface layer of the base resin reveals more of the inner lattice of conductive loading in the molded article 264.

Referring now to FIG. 14, a ninth preferred embodiment of the present invention is illustrated. In this embodiment, the surface of the article 304 is processed using a mechanical abrasive, or polishing, method 300. The molded conductive loaded resin-based material article 304 is polished to mechanically remove a layer of the base resin material. In the illustrated embodiment, a polishing tool 312 and 308 removes the material by an abrasive action. Preferably, a motor-driven polisher 312 is used. Alternatively, a hand-driven polishing tool may be used. An abrasive material, such as a silica-based material typically used in sand paper, is used. In one embodiment, this abrasive material 308 is adhered to the pad 308 of the polishing tool 312. In another embodiment, a polishing compound 316 is applied to the pad 308 or to the molded article 304. The surface of the molded article 304 is abraded to remove a layer of the base resin. Preferably, the polishing does little damage to the conductive loading material of the molded article 304. The removal of a surface layer of the base resin reveals more of the inner lattice of conductive loading in the molded article 304.

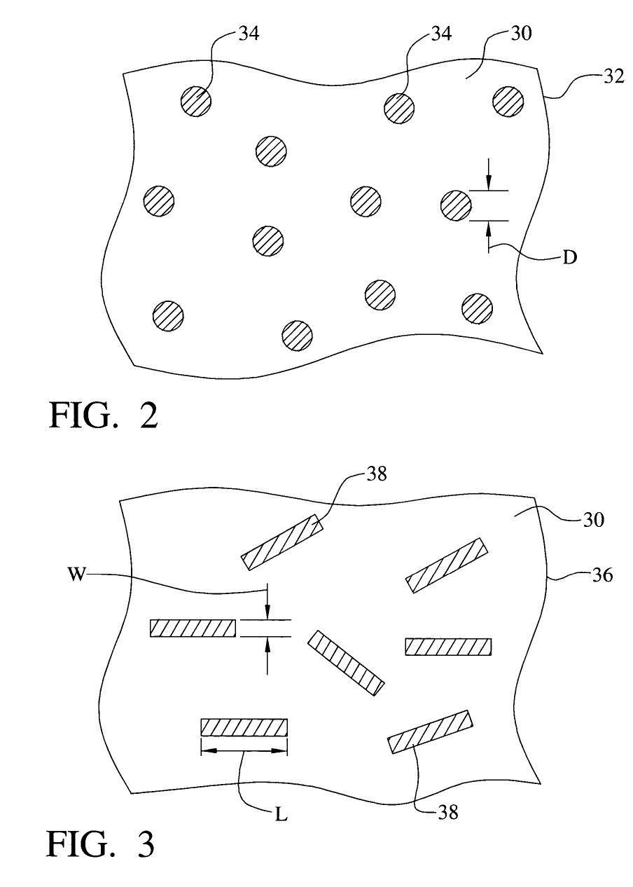

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

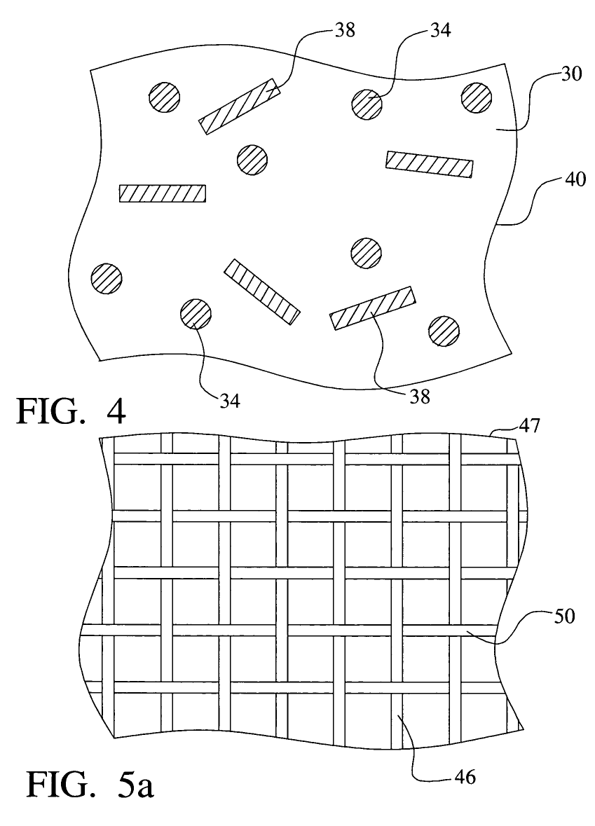

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

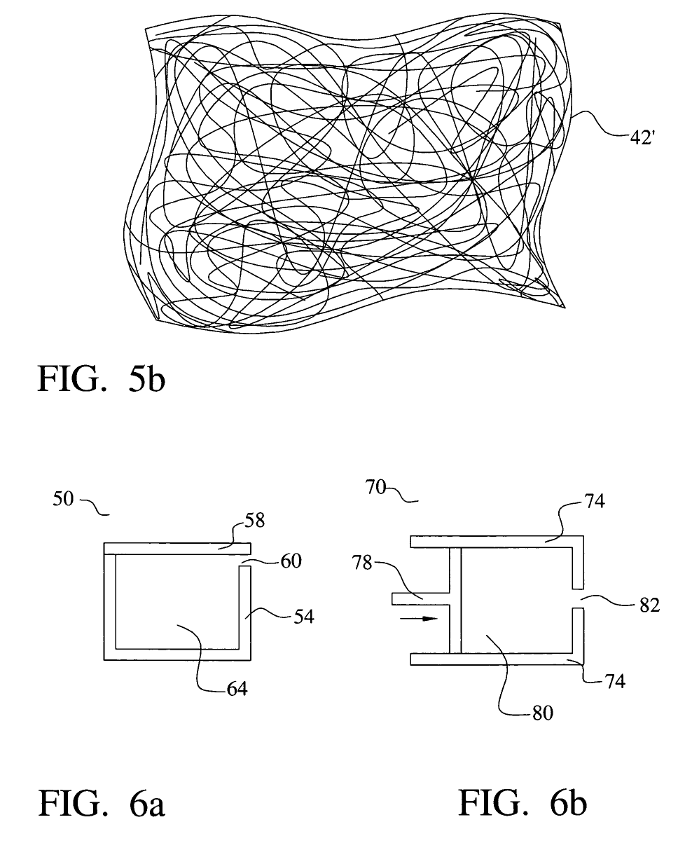

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Articles formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the articles are removed.

FIG. 6b shows a simplified schematic diagram of an extruder 70 for forming articles using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective method of surface preparation of an article molded of conductive loaded resin-based material is achieved. The method improves the surface conductivity of the conductive loaded resin-based material. The method is applicable using a variety of processing equipment.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A device comprising conductive loaded, resin-based material comprising conductive materials in a base resin host wherein said conductive loaded, resin-based material is molded to form surfaces of said device and wherein at least one said molded surface is processed, after molding, to remove a portion of said base resin host and to expose said conductive material.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 wherein said surface is processed by exposure to a solvent.

7. The device according to claim 1 wherein said surface is processed by exposure to a laser light.

8. The device according to claim 1 wherein said surface is processed by exposure to a high pressure jet.

9. The device according to claim 1 wherein said surface is processed by exposure to a mechanical abrasive.

10. A device comprising conductive loaded, resin-based material comprising conductive materials in a base resin host wherein said conductive loaded, resin-based material is molded to form surfaces of said device, wherein between 20% and 40% by weight of said conductive loaded, resin-based material is said conductive material, and wherein at least one said molded surface is processed with a solvent, after molding, to remove a portion of said base resin host and to expose said conductive material.

11. The device according to claim 10 wherein said conductive materials are nickel plated carbon micron fiber, stainless steel micron fiber, copper micron fiber, silver micron fiber or combinations thereof.

12. The device according to claim 10 wherein said conductive materials comprise micron conductive fiber and conductive powder.

13. The device according to claim 12 wherein said conductive powder is nickel, copper, or silver.

14. The device according to claim 12 wherein said conductive powder is a non-conductive material with a metal plating of nickel, copper, silver, or alloys thereof.

15. The device according to claim 10 wherein said solvent is an organic solvent.

16. The device according to claim 10 wherein said solvent is an inorganic solvent.

17. A device comprising conductive loaded, resin-based material comprising micron conductive fiber in a base resin host wherein said conductive loaded, resin-based material is molded to form surfaces of said device and wherein at least one said molded surface is processed with a high pressure jet, after molding, to remove a portion of said base resin host and to expose said micron conductive fiber.

18. The device according to claim 17 wherein said micron conductive fiber is stainless steel.

19. The device according to claim 17 further comprising conductive powder.

20. The device according to claim 17 wherein said micron conductive fiber has a diameter of between about 3 μm and about 12 μm and a length of between about 2 mm and about 14 mm.
